(19) United States
(12) Patent Application Publication
(10) Pub. No.: US 2026/0177798 A1
(43) Pub. Date: Jun. 25, 2026

(54) OPTICAL IMAGING SYSTEM COMPRISING A SCANNING IMAGING DEVICE, METHOD, SYSTEM, AND COMPUTER PROGRAM

(71) Applicant: Leica Microsystems CMS GmbH, Wetzlar (DE)

(72) Inventors: Kai RITSCHEL, Wetzlar (DE); Mate BELJAN, Wetzlar (DE)

(21) Appl. No.: 19/125,311

(22) PCT Filed: Nov. 9, 2023
(86) PCT No.: PCT/EP2023/081294

§ 371 Date: Apr. 29, 2025

(30) Foreign Application Priority Data
Nov. 9, 2022 (DE) 10 2022 129 551.6

(51) Int. Cl. G02B 21/00

(52) U.S. Cl. CPC G02B 21/0072; G02B 21/008

(57) ABSTRACT

A method for an optical imaging system having a scanning imaging device includes obtaining sensor data from a detector of the scanning imaging device. The sensor data include a representation of a pattern captured by the detector. The method further includes determining a characteristic geometry of the representation of the pattern, comparing the characteristic geometry with a reference geometry in order to determine a comparison result, determining at least one calibration parameter for calibrating at least one control unit for moving a beam-conducting element of the scanning imaging device based on the comparison result, and operating the at least one control unit based on the at least one calibration parameter.

### CROSS REFERENCE TO RELATED APPLICATIONS

This application is a U.S. National Phase application under 35 U.S.C. § 371 of International Application No. PCT/EP2023/081294, filed on Nov. 9, 2023, and claims benefit to German Patent Application No. DE 10 2022 129 551.6, filed on Nov. 9, 2022. The International Application was published in German on May 16, 2024 as WO 2024/100189 A1 under PCT Article 21 (2).

### FIELD

Embodiments of the invention relate to an optical imaging system comprising a scanning imaging device, to a method, to a system, and to a computer program for such an optical imaging system.

### BACKGROUND

Confocal microscopy technology, which is an example of scanning microscopy, is based in many implementations on a two-dimensionally pivoting mirror. The two movements of the mirror are preferably precisely coordinated so that the imaged area of a single pixel is the same in x and y (i.e. along two lateral dimensions), as otherwise the image will contain strong distortions. Depending on the algorithm used, such a distorted image can, for example, have an impact on a point spread function used in a deconvolution operation to process the sensor data of the confocal microscope. A distorted image is also called a non-isotropic image. The isotropy of the image becomes even more important when confocal imaging is to be registered with other modalities, such as a wide-field image provided by a microscope camera sensor.

Generally, a calibration standard, which is built into the scanner, is used to calibrate confocal microscopes. This calibration standard is used to adjust the control of the galvanometer scanners (“galvos” for short) of the confocal microscope. By using the calibration standard, the technical service can ensure an isotropic representation. In most cases, a double-cross calibration target, which has no periodic properties, is used.

Such a double-cross calibration target, as is used in most cases, cannot be displayed by a camera of the confocal microscope because it is arranged outside the beam path of the camera. This means a limitation in optical imaging systems that, in addition to a scanning imaging device such as a confocal microscope, also have a camera-based imaging device, for example in order to provide a wide-field image. In some of these optical imaging systems, it may be desirable to be able to switch seamlessly between the scanning imaging device and the camera-based imaging device. For this purpose, in addition to the isotropy of the images, an identical field of view (i.e. an identical imaged area, also known as the field of view) of the two imaging devices is sought, as well as knowledge about the scaling of the image data of the imaging device, so that, if necessary, a suitable optical overlay can be generated that is superimposed on the image data of the imaging device. However, without a common calibration target, it is difficult to ensure that the field of view, i.e. the imaged area of the two modalities, is identical.

Currently therefore, in some systems, a laborious calibration procedure is carried out manually during production in order to try to set the field of view identically and at the same time isotropically via the galvo controller (via the parameters scaling in the x-dimension, scaling in the x-dimension, offset in the x-dimension and offset in the y-dimension). The quality assessment is carried out only visually (by means of superimposed representations of a technical sample). A simultaneous setting and evaluation of the four parameters mentioned above is necessary because the parameters cannot be considered independently of each other. Manual calibration takes a long time, is complicated, and potentially error-prone. It is an iterative process because offset and scaling cannot be visually evaluated independently of each other. The manual calibration checks the isotropy of the confocal scan only relative to the wide-field image and not independently of it (by means of the overlay display).

Possible errors in calibration lead to display deviations that are difficult to identify and, if unnoticed, may in the worst case lead to incorrect interpretation of the image data. Deviations can also negatively influence subsequent alignment and its quality. For example, a confocally scanned dye may appear at a different location compared to an IMC (imaging mass cytometry) image and may cover a different shape, thus excluding existing colocalization.

There is a need for an improved concept for calibrating scanning imaging devices, in particular scanning imaging devices in optical imaging systems with multiple imaging devices, for example in order to harmonize the fields of view of the two imaging devices.

### SUMMARY

Embodiments of the present invention provide a method for an optical imaging system having a scanning imaging device. The method includes obtaining sensor data from a detector of the scanning imaging device. The sensor data include a representation of a pattern captured by the detector. The method further includes determining a characteristic geometry of the representation of the pattern, comparing the characteristic geometry with a reference geometry in order to determine a comparison result, determining at least one calibration parameter for calibrating at least one control unit for moving a beam-conducting element of the scanning imaging device based on the comparison result, and operating the at least one control unit based pm the at least one calibration parameter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following: Some examples of devices and/or methods are explained in greater detail below with reference to the attached figures merely by way of example. In the figures:

FIGS. 1a and 1b show flowcharts of examples of a method for an optical imaging system with a scanning imaging device according to some embodiments;

FIGS. 2a and 2b show schematic drawings of examples of an optical imaging system with a scanning imaging device according to some embodiments;

FIG. 3 shows a flowchart of an example of a sequence of the calibration method according to some embodiments;

FIG. 4 shows a schematic representation of the effect of a calibration according to some embodiments; and

FIG. 5 shows a schematic representation of a system with an optical imaging device and a computer system according to some embodiments.

### DETAILED DESCRIPTION

Various exemplary embodiments of the present disclosure are based on the finding that a geometric analysis of a calibration pattern is suitable for achieving isotropy in image data of a scanning imaging device, such as a confocal microscope, by determining suitable calibration parameters for the scanner mirror(s). Furthermore, this geometric analysis, for example when applied to both image data from the scanning imaging device and image data from another optical (camera-based) imaging device, can also be used to harmonize the fields of view of the two imaging devices. This avoids the time-consuming manual calibration of the optical imaging system, achieves a higher calibration accuracy and reduces susceptibility to errors. In addition, calibration can be repeated in the field without the need for a technician, so that the isotropy and the consistency of the fields of view can be ensured even after extended periods of use.

Various aspects of the present disclosure relate to a method for an optical imaging system having a scanning imaging device. The method involves obtaining sensor data of a detector of the scanning imaging device. These sensor data comprise a representation of a pattern which has been captured by the detector. The method further comprises determining a characteristic geometry of the representation of the pattern. The method further comprises comparing the characteristic geometry with a reference geometry in order to determine a comparison result. The method further comprises determining at least one calibration parameter in order to calibrate at least one control unit for moving a beam-conducting element of the scanning imaging device on the basis of the comparison result. The method further comprises operating the at least one control unit on the basis of the at least one calibration parameter. By determining the characteristic geometry and comparing it with the reference geometry, it is easy to determine mathematically how the representation of the pattern differs from a reference representation of the pattern (e.g. as regards isotropy). In addition, if desired, how the field of view of the scanning imaging device differs from a reference field of view can be determined. These findings can be used to determine one or more suitable calibration parameters that can be used to control the beam-conducting element in such a way that the scanning imaging device generates sensor data that will thereafter correspond to the specifications of the reference geometry.

Basically, there are several ways of obtaining the reference geometry. For example, the reference geometry can be generated by the optical imaging system. Accordingly, the method may also include determining the reference geometry. As stated above, the present concept is suitable, for example, for harmonizing the fields of view of a camera-based imaging device and a scanning imaging device. For example, the camera-based optical imaging device can be used to determine the reference geometry. The method may thus further comprise obtaining further sensor data from a further optical imaging sensor of the optical imaging system. The further sensor data include a further representation of the pattern captured by the additional optical imaging sensor. The method may include determining the reference geometry on the basis of the further representation of the pattern. Accordingly, the at least one calibration parameter can be determined here in such a way that the representation of the scanning imaging device is adapted to the representation of the further optical imaging sensor.

By comparing the characteristic geometry with the reference geometry, it can primarily be determined that suitable scaling factors are used to calibrate at least one control unit. If these scaling factors are applied to the display, an adjusted display with correct scaling can be calculated. Accordingly, the method may include an adjustment, such as a scaling, of the representation on the basis of the comparison result. According to this, the x and y offset (hereinafter referred to as the difference value) between the adjusted representation and the further representation generated by the further optical imaging sensor can now be determined. By means of the difference value, the field of view of the scanning imaging device can now also be shifted so that the fields of view can be aligned. For example, the method may comprise determining a difference value between the adjusted representation and the further representation, and determining the at least one calibration parameter further on the basis of the difference value.

Additionally, or alternatively, this difference value can also be obtained after application of the at least one calibration parameter on the basis of newly acquired image data of the scanning imaging device. For example, after application of the at least one calibration parameter, the method may comprise re-obtaining the sensor data with the representation of the pattern, determining a difference value between the newly obtained representation and the further representation, and determining the at least one calibration parameter further on the basis of the difference value. As a result, the offset between the fields of view of the two imaging devices can be determined and (further) reduced.

Alternatively, the reference geometry can be determined on the basis of sensor data from the scanning imaging device, for example in order to be able to carry out a new automated recalibration after prolonged use of the imaging system. For example, the method may include determining the reference geometry on the basis of sensor data of the scanning imaging device following a factory calibration of the scanning imaging device.

Alternatively, the reference geometry can be specified at the factory or by another scanning imaging device. For example, the reference geometry may be a factory-defined reference geometry or a geometry determined by another scanning imaging device and stored in a memory of the optical imaging system. As a result, a uniform calibration can be achieved across devices.

As previously stated, one possible goal is to align the field of view of the scanning imaging device with the field of view of a camera-based imaging device. For example, the at least one calibration parameter can be determined such that, after applying the at least one calibration parameter, a field of view of the scanning imaging device corresponds to a field of view of another optical imaging sensor of the optical imaging system within a tolerance range. This allows the operation of the optical imaging system to switch seamlessly between image data from the scanning imaging device and image data from the optical imaging sensor.

This can be achieved by aligning the characteristic geometry of the scanning imaging device with the reference geometry. For example, the at least one calibration parameter may be determined such that, after application of the at least one calibration parameter and re-obtaining the sensor data and determining the characteristic geometry, the characteristic geometry corresponds to the reference geometry within a tolerance range. This can be used as an indicator of the calibration having been successful.

The accuracy of the calibration can be increased if necessary by iteratively repeating the proposed procedure so that the difference between characteristic geometry and reference geometry is iteratively reduced. For example, the comparison result can be determined repeatedly and at least one calibration parameter can be adjusted repeatedly.

In some cases, aging-related effects may prevent the beam-conducting element from being controlled as desired in order to align the fields of view (or achieve isotropy). In these cases, a warning may be issued to signal to the user of the optical imaging system that repair and/or replacement of the respective component is necessary. For example, the method may further comprise providing a warning if the characteristic geometry does not correspond to the reference geometry within a tolerance range following repeated adjustment of the at least one calibration parameter. This prevents the optical imaging system from operating with a faulty component.

In the present concept, a characteristic geometry is calculated and compared with a reference geometry. One way to determine this characteristic geometry is to determine distances between elements of the pattern. This is in turn facilitated by the fact that the pattern is a periodic pattern, i.e. a pattern in which elements occur repeatedly according to a given periodicity. For example, the pattern may be a periodic pattern and the characteristic geometry may include a periodicity of the representation of the periodic pattern. The periodicity is a numerical value that can be easily compared to a periodicity of the reference geometry and can be used (directly) to set the aforementioned scaling. For example, the periodicity can be calculated with little computational effort and without segmenting the sensor data by calculating an auto-phase correlation. Consequently, the periodicity can be determined by calculating an auto-phase correlation.

In scanning imaging devices, an object to be scanned is usually scanned according to a two-dimensional scanning pattern. The beam-conducting element is moved accordingly in two dimensions, which can be calibrated separately. Consequently, the pattern can be a two-dimensional periodic pattern. The characteristic geometry can be a periodicity of the representation of the two-dimensional periodic pattern in two dimensions.

Accordingly, the beam-conducting element can also be movable in two dimensions by the control unit. The at least one calibration parameter may comprise at least a first scaling factor for scaling the movement of the beam-conducting element in a first dimension and a second scaling factor for scaling the movement of the beam-conducting element in a second dimension. As a result, the calibration of the scanning imaging device for scanning can be performed according to the two-dimensional scanning pattern.

The calibration can be performed at different times. For example, the characteristic geometry and the comparison result can be performed when starting up the scanning imaging device. For example, automatic calibration can be performed at (or each) start-up of the scanning imaging device so that measurement accuracy (and compliance with the field of view of the optical imaging sensor) is continuously ensured.

Alternatively or additionally, calibration can be performed sporadically, for example after a shock to the optical imaging system. Consequently, the characteristic geometry and the comparison result can be determined after detecting a shock to the optical imaging system. This is recommended because the shock is expected to cause for example a change in the movement characteristics of the beam-conducting element and/or a change in the field of view of the optical imaging sensor.

Additionally, or alternatively, the characteristic geometry and the comparison result can be determined according to a prespecified schedule. Here, too, the measurement accuracy (and agreement with the field of view of the optical imaging sensor) can be continuously ensured.

Some aspects of the present disclosure relate to a system for an optical imaging system having a scanning imaging device. The system comprises one or more processors and one or more storage devices. The system is designed to carry out the method presented above. Some aspects of the present disclosure further relate to an optical imaging system comprising a scanning imaging device and the previously presented system.

In the present disclosure, the term scanning imaging device is used. Examples of scanning imaging devices include scanning electron microscopes and two-photon microscopes. In particular, however, the scanning imaging device can, as mentioned at the outset, be a confocal imaging device, such as a confocal microscope (confocal laser scanning microscope, CLSM).

There are different places where the pattern can be arranged. For example, the pattern may be imaged on a sample carrier, wherein the sample carrier may be inserted into a sample holder of the optical imaging system for calibration or may be arranged on a sample stage of the optical imaging system. Alternatively, the sample stage of the optical imaging system can comprise the pattern. This allows calibration to be performed without the need for a user to insert a sample carrier containing the pattern.

Alternatively, the optical imaging system may comprise a housing, wherein the pattern is disposed within the housing and outside a field of view of the scanning imaging device accessible to users of the optical imaging system. This also makes possible an automatic calibration without the involvement of a user of the optical imaging system. In this case, the system may be configured to control the control unit such that the pattern outside the field of view accessible to users of the optical imaging system is detected by the detector of the scanning imaging device. This allows the pattern to be captured for calibration purposes that is outside the field of view of the scanning imaging device, and which is accessible to users of the optical imaging system, without interfering with normal use of the scanning imaging device.

Some aspects of the present disclosure also relate to a computer program having a program code for carrying out the method presented above.

Some examples will now be described in greater detail with reference to the accompanying figures. However, further possible examples are not limited to the features of these embodiments described in detail. Furthermore, the terminology used herein to describe particular examples is not intended to be limiting of other possible examples.

When two elements A and B are combined using an “or”, this is to be understood as disclosing all possible combinations, i.e. only A, only B and A and B, unless expressly defined otherwise in the individual case. As an alternative formulation for the same combinations, “at least one of A and B” or “A and/or B” can be used. This applies equivalently to combinations of more than two elements. The term “and/or” can be abbreviated as “/” and includes all combinations of one or more of the associated listed items.

If a singular form, such as “a/an” and “the”, is used and the use of only a single element is neither explicitly nor implicitly defined as mandatory, further examples may also use multiple elements to implement the same function. Where a function is described below as being implemented using multiple elements, further examples may implement the same function using a single element or a single processing entity.

Although some aspects have been described within the framework of a device, it is clear that such aspects also constitute a description of the corresponding method, a block or a device corresponding to a method step, or a function of a method step. Similarly, aspects described within the framework of a method step also constitute a description of a corresponding block or element, or a feature of a corresponding device.

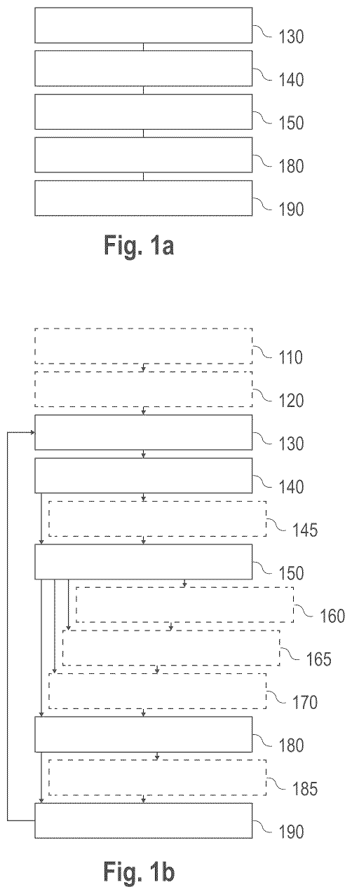

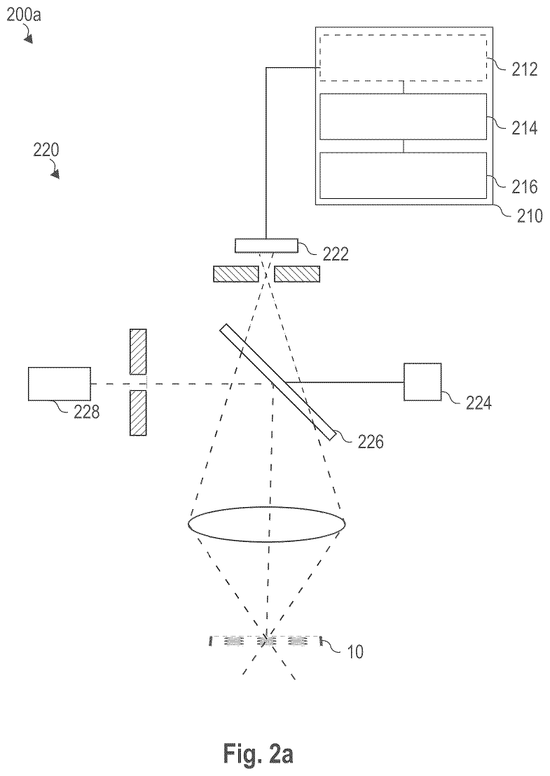

FIGS. 1a and 1b show flowcharts of examples of a method for an optical imaging system 200a; 200b with a scanning imaging device 220 (the reference signs of the optical imaging system refer to FIGS. 2a and 2b). The method includes obtaining 130 sensor data from a detector 222 of the scanning imaging device 220. The sensor data includes a representation of a pattern 10; 20; 30 (shown in FIG. 2a or 2b), which was captured by the detector. The method further comprises determining 140 a characteristic geometry of the representation of the pattern. The method further comprises comparing 150 the characteristic geometry to a reference geometry in order to determine a comparison result. The method further comprises determining 180 at least one calibration parameter in order to calibrate at least one control unit 224 for moving a beam-conducting element 226 of the scanning imaging device on the basis of the comparison result. The method further comprises operating 190 the at least one control unit on the basis of the at least one calibration parameter.

FIG. 1a shows a basic first version of the method. The method may further comprise optional further features, which are shown in FIG. 1b as blocks with dashed lines and which will be explained in the course of the further description of FIGS. 1a to 2b.

The method in FIGS. 1a and 1b relates to an optical imaging system. In FIGS. 2a and 2b, schematic drawings of examples of such an optical imaging system 200a; 200b with a scanning imaging device are shown. The optical imaging systems 200; 200b each comprise the scanning imaging device 220 and a system 210 configured to carry out the method of FIGS. 1a and/or 1b. The system 210 can be implemented as a computer system. For example, the system 210 comprises one or more processors and one or more storage devices 216. Optionally, the system 210 may further comprise one or more interfaces 212. The one or more processors 214 are coupled to the one or more storage devices and to the one or more interfaces 212. Here, the one or more processors 214 are configured to provide the functionality of the system 210, in interaction with the one or more interfaces 212 (for exchanging information with other components of the optical imaging system, such as the detector 220 of the scanning imaging device, an optical imaging sensor 230 (shown in FIG. 2b), or a screen of the optical imaging system (not shown)) and with the one or more storage devices 216 (for storing and retrieving information, such as machine-readable instructions comprising program code for the one or more processors 214). In general, the functionality of the one or more processors 214 may be implemented by the one or more processors 214 by way of the one or more processors executing the machine-readable instructions. Accordingly, a functionality attributed to the one or more processors 214 may be defined by one or more instructions from a plurality of machine-readable instructions. The system 210 may include the machine-readable instructions, e.g. in the one or more storage devices 216.

The features of the method in FIGS. 1a and 1b of the system, a corresponding computer program and the optical imaging systems 200a; 200b in FIGS. 2a and 2b are explained primarily with reference to the method and the optical imaging system. It is obvious that features explained in connection with the method can also be transferred to the corresponding system and computer program, since the system is designed to carry out the method and the computer program represents an implementation of the method. Features explained with reference to the optical imaging systems 200; 200b also affect the method, the system and the computer program.

The present concept relates to an optical imaging system with a scanning imaging device. These terms are used because the present concept can be applied to a variety of different optical imaging systems. For example, the imaging system can be a microscope system or an exoscope system, wherein an exoscope system is an optical imaging system that, unlike the microscope system, is used exclusively via a screen or a head-mounted display (screen that is worn similar to glasses). In addition, an exoscope is usually used from a greater distance. The term optical imaging system is used in order to clarify that, on the one hand, it is a system with optical components and, on the other hand, in addition to the optical components, it includes other components, such as the system 210. The optical imaging system may include, in addition to the optical components and the system 210, other components such as an input device (such as a touchscreen, a keyboard, or control buttons), a display, a sample stage, a housing, etc.

The optical imaging system comprises at least one optical component. In the present case, the optical imaging system comprises at least the scanning imaging device 220 as an optical component. Furthermore, as shown in FIG. 2b, the optical imaging system may also include another optical imaging sensor 230.

A scanning imaging device is an optical component designed to generate image data by scanning a plurality of positions of a sample. An example of a scanning imaging device is a confocal microscope. In other words, the scanning imaging device may be a confocal imaging device, such as a confocal microscope. Other examples of scanning imaging devices are the two-photon microscope and the scanning electron microscope. In all cases, a beam is directed by a beam-conducting element to the aforementioned plurality of positions of the sample. One or more detectors are used to detect interactions of the beam with the sample, such as reflection, photoemission (in the case of fluorescence), emitted radiation or electrons. In the case of confocal microscopy and two-photon microscopy, the beam is a laser beam, in the case of scanning electron microscopy it is an electron beam. This beam is directed to the different positions of the sample (according to a grid) by means of the beam-conducting element. In the case of confocal microscopy and two-photon microscopy, a mirror or other reflective element is usually used (as shown in FIG. 2a), while in the case of scanning electron microscopy, coils are used to direct the electron beam. The present disclosure is concerned with the calibration of control of this beam-conducting element by means of the control unit. In the case of confocal microscopy and two-photon microscopy, the control unit can, for example, comprise a so-called galvo motor or a micro-electro-mechanical system (MEMS) that carries out the movement of the beam-conducting element. In the case of scanning electron microscopy, the control unit may comprise a control circuit for controlling the coils.

For example, FIG. 2a shows the characteristic structure of a confocal microscope. On the left-hand side, the laser emitter 228 is shown, which emits laser light onto the mirror 226, which is moved by the control unit 224 in order to scan the pattern 10. In some other scanning imaging devices, instead of one mirror, several mirrors are used, each controlled by a control unit.

The calibration of the control of the beam-conducting element by the control unit is based on the evaluation of sensor data from the detector (which detects the interactions of the beam with the sample) of the scanning imaging device. A characteristic geometry of a representation of a pattern is determined, compared with a reference geometry, and on the basis of the comparison, calibration parameters for calibrating the control unit are determined.

In the following, as an example a confocal microscope is used as a scanning imaging device. The principle can also be transferred correspondingly to other scanning imaging devices.

To determine the characteristic geometry of the representation of the pattern, the sensor data from the detector are evaluated. For example, image data can be generated from the sensor data that include the representation of the pattern. Using image processing, the image data are analyzed to determine the characteristic geometry on the basis of the representation of the pattern contained in the image data. The characteristic geometry can, for example, correspond to an absolute or relative extent of one or more geometric elements of the pattern in the representation of the pattern, which can be determined by means of image processing.

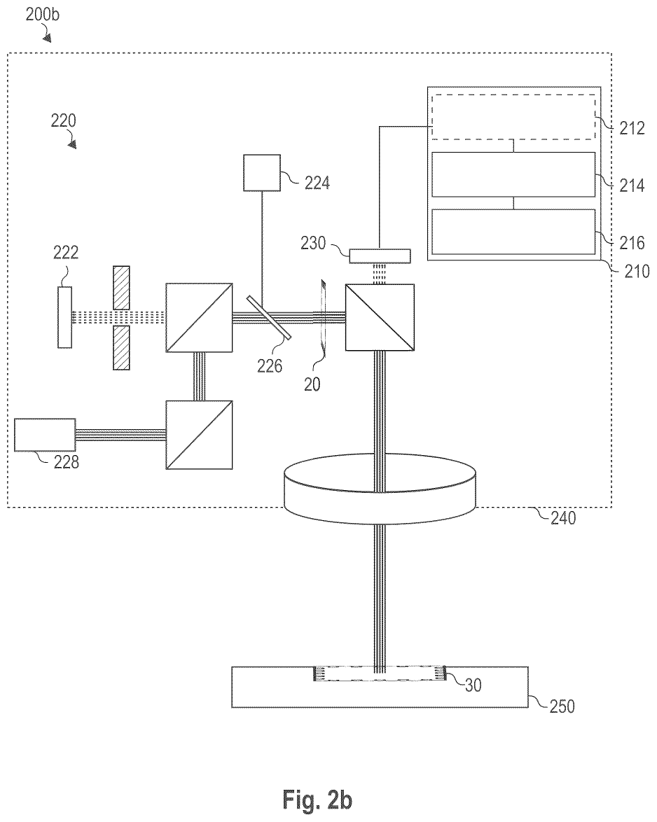

Preferably, however, the characteristic geometry corresponds to or comprises a periodicity of elements of the pattern. For example, the pattern may be a periodic pattern, i.e. a pattern in which one or more elements (such as dots, dashes, triangles, squares, etc.) are repeated at regular intervals along at least one lateral dimension of the pattern. As shown in FIG. 3, the pattern (in this case the calibration standard 310) may, for example, be a two-dimensional periodic pattern, such as a two-dimensional periodic pattern of dots. The characteristic geometry can thus be a periodicity of the representation of the two-dimensional periodic pattern in two dimensions. The periodicity corresponds to the distance between two adjacent elements of the repeatedly displayed elements of the pattern, for example the distance between the centers of two horizontally or vertically adjacent points in the pattern shown in FIG. 3. Such a periodicity can be calculated, for example, by calculating an auto-phase correlation. Accordingly, as shown in FIG. 1b, the method may include calculating 145 an auto-phase correlation. When calculating the auto-phase correlation, a 2D Fourier transform is applied to the image data and the cross-power spectrum is calculated between the 2D Fourier transform version of the image data and the 2D Fourier transform version of the image data (i.e. between the same 2D Fourier transform version of the image data, making it the auto-phase correlation). The result is transformed back by an inverse Fourier transform. The periodicity can now be determined by determining the distances between the peaks in the back-transformed version.

This characteristic geometry (e.g. the determined periodicity in one or two lateral dimensions) is now compared with the reference geometry in order to determine the comparison result. The reference geometry may also correspond to an absolute or relative extent of one or more geometric elements of the pattern, or, preferably, to a reference periodicity in one or two lateral dimensions.

The reference geometry can come from various sources. For example, the reference geometry may be a factory-defined reference geometry or a geometry determined by another scanning imaging device that is stored in a memory 216 (i.e. in a storage device 216 of the one or more storage devices of the system) of the optical imaging system. This can be factory-specified for a variety of optical imaging systems or, in the laboratory of the user of the optical imaging system, it can be created by an optical imaging system for a fleet of similar optical imaging systems.

Alternatively, the reference geometry can be determined by means of the optical imaging system. Thus, as further shown in FIG. 1b, the method may include determining 120 the reference geometry. For example, the scanning imaging device can be manually calibrated and, in the calibrated state, used to determine the reference geometry. In other words, the method may include determining 120 the reference geometry on the basis of sensor data of the scanning imaging device following a factory calibration of the scanning imaging device. For this purpose, the characteristic geometry can be determined as described above and used thenceforth as the reference geometry. For this purpose, the reference geometry can be stored in a memory 216 of the optical imaging system.

As already explained above, the present concept can also be used in particular not only to ensure the isotropy of the image data that can be obtained from the sensor data of the scanning imaging device, but also to adapt a field of view of the scanning imaging device to a field of view of another imaging device (the further optical imaging sensor 230 in FIG. 2b).

FIG. 2b shows an optical imaging system comprising a first scanning imaging device (a confocal microscope 220) and a second optical imaging device (formed by the further optical imaging sensor 230). In order to create an intuitive operation of an optical imaging system with two imaging devices, it may be desirable for the fields of view of the two imaging devices to correspond. This can be made possible by the proposed concept by using the sensor data of the second optical imaging device to define the reference geometry. In the present case, the sensor data of the optical imaging sensor 230 are used for this purpose, since the field of view of the optical imaging sensor cannot be corrected to the field of view of the scanning imaging device without loss of image quality, but the other way around is possible. Ensuring isotropy is also less of a problem in the sensor data/image data of the optical imaging sensor, in contrast to the sensor data of the scanning imaging device.

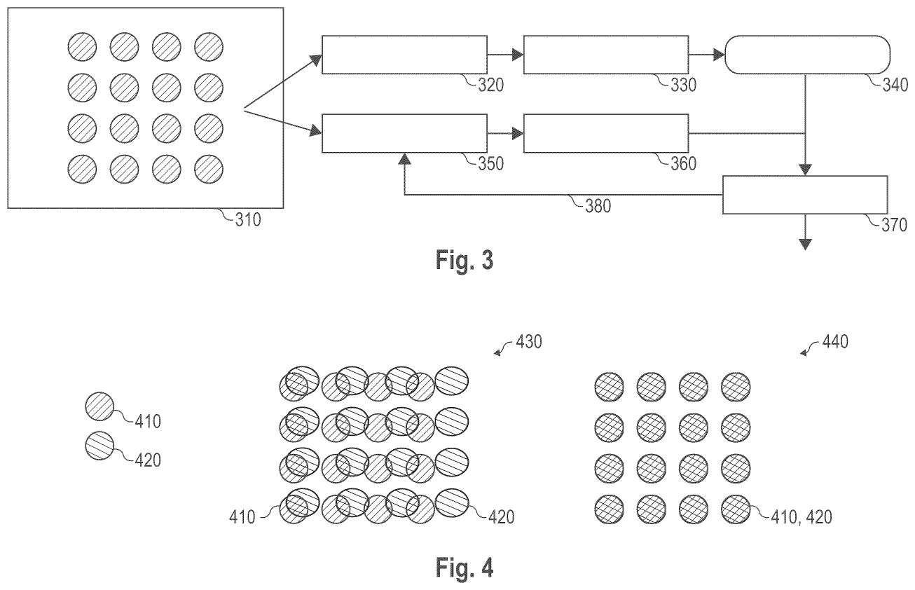

Thus, as further shown in FIG. 1b, the method may further comprise obtaining 110 further sensor data of the further optical imaging sensor 230 of the optical imaging system. The further sensor data include a further representation of the pattern captured by the further optical imaging sensor. On the basis of these further sensor data, which may correspond to image data, a characteristic geometry (as previously explained) of the further representation of the pattern can now also be determined and used as a reference geometry and, optionally, saved. Accordingly, the method may include determining 120 the reference geometry on the basis of the further representation of the pattern. A more detailed example of this is discussed, for example, in connection with FIGS. 3 and 4.

The determination of the characteristic geometry or the reference geometry is based on the capture of the pattern by the respective imaging device. The pattern can be arranged at different locations in the optical imaging system. In FIG. 2b two locations are shown by way of example. For the pattern to be “seen” by both imaging devices, the pattern 30 can be imaged, for example, on a sample carrier. The sample carrier can in turn be inserted into a sample holder (not shown) of the optical imaging system for calibration or can be arranged on a sample stage 250 of the optical imaging system. Alternatively, the sample stage 250 may include the pattern 30, i.e. the pattern may be printed or glued onto the sample stage.

Alternatively, for example in the case in which the reference information is not to be determined by means of the further optical imaging sensor 230, the pattern 20, as further shown in FIG. 2b, can also be arranged within a housing 240, but outside the field of view usable for a user. For this purpose, the beam-conducting element can be tilted further for calibration in order to increase the field of view of the scanning imaging device 220 during calibration. The method may now comprise controlling the control unit such that the pattern outside the field of view accessible to users of the optical imaging system is detected by the detector of the scanning imaging device.

Once the characteristic geometry, and optionally the reference geometry, have been determined, the subsequent comparison 150 of the characteristic geometry with the reference geometry can be carried out in order to determine the comparison result. For example, a relationship can be formed between the characteristic geometry and the reference geometry, for example between the periodicities. This ratio can, for example, be determined separately for both lateral dimensions. Consequently, the comparison result may include a ratio between the characteristic geometry and the reference geometry (in two dimensions). This ratio can now be used to determine the at least one calibration parameter.

The use of a ratio between the geometries is due to the nature of the movement of the beam-conducting element. A key aspect of the calibration is the scaling of the movement, i.e. how far the mirror moves for a given input value. For example, the beam-conducting element can be moved in two dimensions by the control unit. The at least one calibration parameter may now comprise at least a first scaling factor for scaling the movement of the beam-conducting element in a first (lateral) dimension and a second scaling factor for scaling the movement of the beam-conducting element in a second (lateral) dimension (orthogonal to the first dimension). These scaling factors now determine how far the mirror moves for a given input value. Since the reference geometry represents the target of the calibration, i.e. if the characteristic geometry corresponds to the reference geometry no further calibration will be necessary, the relationship between the characteristic geometry and the reference geometry being usable to determine to what extent the scaling needs to be adapted.

If the aim of the calibration is to align the field of view of the scanning imaging device with the field of view of the other optical imaging sensor, a lateral offset between the fields of view will also need to be taken into account in addition to the scaling factor. This can be seen, for example, in FIG. 4, where the elements in the representations 410; 420 of the pattern not only have different scales but are also laterally offset in two dimensions. This (two-dimensional) offset can be determined by adjusting (i.e. scaling) the representation of the pattern according to the determined scaling factors and by determining the offset on the basis of the adjusted version. For example, as further shown in FIG. 1b, the method may further comprise adapting 160 the representation on the basis of the comparison result and determining 165 a difference value (such as a lateral offset) between the adapted representation and the further representation. On the other hand, the offset can be determined by applying the scaling parameters, obtaining new sensor data from the optical imaging device with a new representation of the pattern, and comparing the characteristic geometry of the new representation with the reference geometry. In other words, after applying the at least one calibration parameter, the method may comprise re-obtaining 130 the sensor data with the representation of the pattern and determining 165 the difference value between the newly obtained representation and the further representation. The at least one calibration parameter can now be further determined on the basis of the difference value 180.

The at least one calibration parameter (which includes the scaling factors and the offset in two lateral dimensions) is ideally determined such that, after calibration, the (newly determined) characteristic geometry corresponds to the reference geometry. In other words, the at least one calibration parameter may be determined such that, after application of the at least one calibration parameter and re-obtaining the sensor data and determination of the characteristic geometry, the characteristic geometry corresponds to the reference geometry within a suitable tolerance range. If this is the case, and especially if the offset is taken into account, the field of view of the scanning imaging device should match the field of view of the wide optical imaging sensor. In other words, the at least one calibration parameter can be determined such that, after application of the at least one calibration parameter, a field of view of the scanning imaging device corresponds to a field of view of another optical imaging sensor of the optical imaging system within a suitable tolerance range. The respective tolerance ranges depend on the application and the selected reference variable.

In some cases, it may happen that at least one calibration parameter cannot be determined in one run such that the result lies within the aforementioned tolerance range. This can be due, for example, to measurement inaccuracies and non-linearities in the control of the movement of the beam-conducting element. For this reason, at least one calibration parameter can be adjusted iteratively until the desired precision is achieved. In other words, the comparison result can be repeatedly determined 150 (by re-obtaining the sensor data, determining the characteristic geometry and comparing it with the reference geometry) and the at least one calibration parameter can be repeatedly adjusted 185 (on the basis of the adjusted comparison result). However, even such an iterative method may not necessarily be successful, for example if the fields of view differ too much or if galvo motors are operating too inaccurately due to increasing age. In this case, as shown in FIG. 1b, the method may further comprise providing 170 a warning if the characteristic geometry does not correspond to the reference geometry within the tolerance range after repeated adjustment of the at least one calibration parameter.

However, if at least one calibration parameter is determined that ensures a sufficiently accurate calibration, the at least one calibration parameter will be usable in operation.

The calibration presented here can be used in a variety of ways. In particular, if the pattern does not need to be manually inserted by a user of the optical imaging system, calibration can be performed automatically and at regular intervals, for example according to a prespecified schedule or at one (or each) start-up of the scanning imaging device. The system can trigger the calibration each time it starts up or according to the schedule. If the pattern is mounted on a sample carrier, it may be necessary for a user to insert the sample carrier or arrange it on the sample stage. Alternatively or in addition to regular calibration, calibration can also be carried out as required. Such a need exists in particular when a new optical imaging sensor 230 is mounted or its position is changed, or when the optical imaging system is transported or is shaken by an impact. The vibration can be detected by the system 210, for example, and the system can perform the calibration in response to the vibration.

In the proposed optical imaging system, in some imaging systems an optical imaging sensor 230 is used which is also referred to as a camera. Accordingly, the optical imaging sensor can be configured to generate the further sensor data, which are imaging sensor data. For example, the one optical imaging sensor of the stereoscopic imaging device may comprise or correspond to an APS (active pixel sensor) or a CCD (charge-coupled device)-based image sensor. In APS-based image sensors, for example, the light at each pixel is captured using a photodetector and an active amplifier of the pixel. APS-based image sensors are often based on CMOS (complementary metal-oxide semiconductor) or S-CMOS (scientific CMOS) technology. In CCD-based image sensors, incoming photons are converted into electron charges at a semiconductor-oxide interface, which are then moved by an image sensor circuit between capacitive bins (sinks) in the image sensors in order to perform imaging.

The system 210 may be configured to obtain (i.e. receive or read out) the sensor data of the detector 222 from the detector of the scanning imaging device 220 and/or to obtain (i.e. receive or read out) the further sensor data of the optical imaging sensor 230 from the optical imaging sensor 230, for example, via the interface 212.

The one or more interfaces 212 of the system 210 may correspond to one or more inputs and/or outputs for receiving and/or transmitting information, which may be present in digital (bit) values according to a specific code within a module, between modules, or between modules of different units. The one or more interfaces 212 may, for example, include interface circuits configured to receive and/or transmit information.

The one or more processors 214 of the system 210 may be implemented by one or more processing units, one or more processing devices, any means of processing such as a processor, a computer, or a programmable hardware component operable with appropriately adapted software. In other words: the described function of the one or more processors 214 can also be implemented in software, which is then executed on one or more programmable hardware components. Such hardware components may include a general-purpose processor (such as a central processing unit), a digital signal processor (DSP), a microcontroller, etc.

The one or more storage devices 216 of the system 210 may include at least one element from the group of computer-readable storage media, such as a magnetic or optical storage medium, e.g. a hard disk drive, a flash memory, a floppy disk, a random access memory (RAM), a programmable read-only memory (PROM), an erasable programmable read-only memory (EPROM), an electrically erasable programmable read-only memory (EEPROM), or a network storage device.

More details and aspects of the method, the system, a corresponding computer program, the optical imaging system and the scanning imaging device are mentioned in connection with the concept or examples described above or below (for example, in connection with FIGS. 3 to 5). The method, the system, the computer program, the optical imaging system and the scanning imaging device may comprise one or more additional optional features corresponding to one or more aspects of the proposed concept or the described examples as described above or below.

Various aspects of the present disclosure relate to a device for automatically calibrating the field of view of an optical imaging device or system, such as a microscope or microscope system, by means of image processing. In particular, some embodiments address the automatic calibration of a field of view of multiple imaging devices.

For this purpose, a shared calibration target (such as the one used in connection with FIGS. 1a to 2b) are used for both modalities. The calibration target can be designed for example as a sample slide. For example, a calibration target can be used which represents a periodic (in x- and y-dimensions) pattern. This periodicity can then be determined, for example, via an auto-phase correlation. The periodicity can, for example, be attributed to the characteristic geometry described in connection with FIGS. 1a to 2b, or represent an aspect of the characteristic geometry. The advantage of using auto-phase correlation is the low technical effort. If necessary, segmentation can be dispensed with. Also to be emphasized is the reduced noise sensitivity compared to conventional targets and algorithms.

The same target can be imaged in the wide field (by a camera-based imaging device, such as the further optical imaging sensor 230 in FIG. 2b) and confocally. The deviation between the confocal image area and the wide-field image area can be determined. For example, the wide-field image can be used as a reference for the scaling to be achieved by the confocal scanner (as regards the scaling in the x-dimension and the y-dimension), since the camera sensors (such as CCD sensors) do not permit modification.

As a result, the confocal image can be limited to the identical image area (of the wide-field camera). At the same time, the isotropy of the image can be ensured, or alternatively at least set to be identical to the wide-field sensor.

FIG. 3 shows a flowchart of an example of a sequence of the calibration method. In the example in FIG. 3, the calibration standard 310 (e.g. the pattern discussed in connection with FIGS. 1a to 2b, which can be a periodic point lattice) is inserted. A wide-field image is then taken, which is used as reference image 320. The microscope modality is then changed to confocal, with the calibration standard 310 remaining in place. Another image of the slide is taken with the confocal scanner in order to obtain the confocal image 350 (also CLSM image, confocal laser scanning microscope image).

For both images 320; 350, the period (periodicity) of the sample in the x-dimension and y-dimension is determined using auto-phase correlation 330; 360 and other morphological operations. The wide-field image is used below as the reference/target value 340, since the camera cannot offer parametrization of this type and is therefore unchangeable. The deviation of the periods in the confocal image compared to the wide-field image allows the relevant settings of the galvo control to be adjusted 370. For example, the x-offset, the y-offset, the x-scaling and the y-scaling are calculated here. The adjustment of these values leads to a modified mirror movement so that the calibration standard, as well as possible, maps identically in confocal and wide field. As a result, the image area and scaling are set identically to the reference image.

For verification, after setting of the values, a confocal image is taken again and processed using the same method. The deviation from the wide-field image may only be within a certain tolerance range. Optionally, a further iteration 380 can be performed on the basis of the confocal image.

Alternatively, an older confocal image can be used to determine the reference 340, for example, if the proposed concept is used to compensate for aging effects or to readjust the image area when changing between different stands.

FIG. 4 shows a schematic representation of the effect of calibration. FIG. 4 shows on the one hand the reference image 410 of the calibration standard and on the other hand the confocal image 420. In an original overlay 430, before the calibration is performed, it can be seen that the confocal image has a larger scaling in the x-dimension and a slightly smaller scaling in the y-dimension. There is also an offset. After correcting the image area, a precise overlay 440 of the representations of the calibration standard is achieved.

The proposed method can further be used to test the settings of the confocal scanner on a captured image by using the periodicity, such as isotropy, distortion, acquisition errors that may arise due to different scanning speeds (isotropy should be maintained at different scanning speeds), etc.

This calibration can be performed automatically or be used to evaluate the current settings and assist in manual adjustment. This results in added value due to the independent evaluation of the scaling and offset values compared to manual calibration. It is also possible to achieve significant time savings in the production of the optical imaging system, while simultaneously increasing quality and reducing calibration costs. Calibration validation also becomes automatable and quantifiable, compared to manual, purely visual evaluation.

In the present case, present exemplary embodiments of the application of the concept to a microscope system comprising a confocal microscope and a wide-field microscope are described here. However, the present concept can also be applied to other optical imaging systems and scanning imaging devices, such as other optical imaging systems comprising a scanning imaging device and a camera-based imaging device.

More details and aspects of the device for automatic calibration of the field of view are mentioned in connection with the concept or examples described previously (e.g. FIGS. 1a to 2b). The device for automatic calibration of the field of view may comprise one or more additional optional features corresponding to one or more aspects of the proposed concept or of the described examples as described above or below.

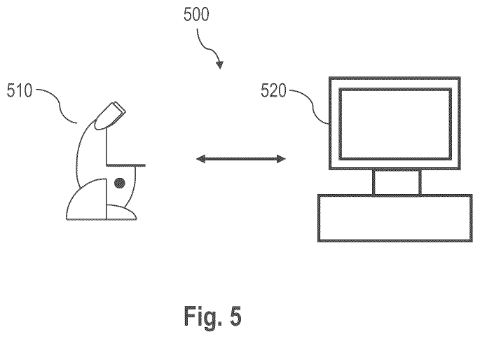

Some embodiments relate to an optical imaging system or to an optical imaging device, such as a microscope system or a microscope comprising a system as described in connection with one or more of FIGS. 1a to 4. Alternatively, an optical imaging device, such as a microscope, may be part of a system as described in connection with one or more of FIGS. 1a to 4, or may be connected thereto. FIG. 5 shows a schematic illustration of a system 500 designed to carry out a method described herein. The system 500 comprises an optical imaging device 510, such as a microscope (such as a scanning microscope or a non-scanning microscope), and a computer system 520. The optical imaging device 510 is designed to capture images and is connected to the computer system 520. The computer system 520 is designed to carry out at least a part of a method described herein. The computer system 520 can be designed to execute a machine learning algorithm. The computer system 520 and the optical imaging device 510 may be separate units, but may also be integrated together in a common housing. The computer system 520 could be part of a central processing system of the optical imaging device 510 and/or the computer system 520 could be part of a sub-component of the optical imaging device 510, such as a sensor, an actuator, a camera or an illumination unit, etc. of the optical imaging device 510.

The computer system 520 may be a local computer device (e.g. personal computer, laptop, tablet computer, or mobile phone) having one or more processors and one or more storage devices, or may be a distributed computer system (e.g. a cloud computing system having one or more processors or one or more storage devices distributed at various locations, e.g. at a local client and/or one or more remote server farms and/or data centers). The computer system 520 can comprise any circuit or combination of circuits. In one exemplary embodiment, the computer system 520 can comprise one or more processors that may be of any type. According to local usage, a processor can refer to any type of computing circuit such as, but not limited to, a microprocessor, a microcontroller, a microprocessor with a complex instruction set (CISC), a microprocessor with a reduced instruction set (RISC), a very long instruction word (VLIW) microprocessor, a graphics processor, a digital signal processor (DSP), a multi-core processor, a field-programmable gate array (FPGA), e.g., of a microscope or microscope component (e.g. camera) or any other type of processor or processing circuit. Other types of circuits that the computer system 520 may comprise may be a specially built circuit, an application-specific integrated circuit (ASIC) or the like, such as one or more circuits (e.g. a communication circuit) for use in wireless devices, such as mobile phones, tablet computers, laptop computers, two-way radios and similar electronic systems. The computer system 520 can comprise one or more storage devices, which may comprise one or more storage elements suitable for the particular application, such as a main memory in the form of addressed memory (RAM, random access memory), one or more hard disks and/or one or more drives that handle removable media, such as CDs, flash memory cards, DVDs and the like. The computer system 520 can also comprise a display device, one or more speakers, and a keyboard and/or control device, which can comprise a mouse, trackball, touchscreen, voice recognition device or any other device that allows a system user to input information into and receive information from the computer system 520.

Some or all of the method steps may be carried out by (or using) a hardware device, such as a processor, microprocessor, programmable computer, or electronic circuit. In some exemplary embodiments, one or more of the most important method steps can be carried out by such a device.

Depending on certain implementation requirements, exemplary embodiments of the invention may be implemented in hardware or software. The implementation may be carried out with a non-volatile storage medium such as a digital storage medium, such as for example a floppy disk, a DVD, a Blu-ray, a CD, a ROM, a PROM and EPROM, an EEPROM or a FLASH memory, on which electronically-readable control signals are stored that interact (or can interact) with a programmable computer system so that the particular method is carried out. The digital storage medium may therefore be computer-readable.

Some exemplary embodiments of the invention comprise a data carrier having electronically readable control signals that can interact with a programmable computer system so that one of the methods described herein is carried out.

In general, exemplary embodiments of the present invention can be implemented as a computer program product having a program code, wherein the program code is operable for carrying out one of the methods when the computer program product is running on a computer. The program code can be stored on a machine-readable carrier, for example.

Further exemplary embodiments comprise the computer program for implementing one of the methods described herein, which computer program is stored on a machine-readable carrier.

In other words, an exemplary embodiment of the present invention is therefore a computer program having a program code for implementing one of the methods described herein when the computer program is running on a computer.

Another exemplary embodiment of the present invention is therefore a storage medium (or a data carrier or a computer-readable medium) comprising a computer program stored thereon for carrying out one of the methods described herein when executed by a processor. The data carrier, the digital storage medium or the recorded medium are generally tangible and/or not transition-free. Another exemplary embodiment of the present invention is a device as described herein which comprises a processor and the storage medium.

Another exemplary embodiment of the invention is therefore a data stream or a signal sequence which represents the computer program for implementing one of the methods described herein. The data stream or the signal sequence can be configured, for example, in such a manner that they are transmitted via a data communication connection, e.g. via the Internet.

Another exemplary embodiment comprises a processing means, e.g. a computer or programmable logic device, configured or adapted to carry out one of the methods described herein.

Another exemplary embodiment comprises a computer on which the computer program for carrying out one of the methods described herein is installed.

Another exemplary embodiment of the invention comprises a device or system configured to transmit (e.g. electronically or optically) to a receiver a computer program for carrying out one of the methods described herein. The receiver may, for example, be a computer, a mobile device, a storage device or the like. The device or system can, for example, comprise a file server for transmitting the computer program to the receiver.

In some exemplary embodiments, a programmable logic device (e.g. a field-programmable gate array, FPGA) can be used to carry out some or all of the functionalities of the methods described herein. In some exemplary embodiments, a field-programmable gate array can operate in conjunction with a microprocessor in order to carry out one of the methods described herein. Generally, the methods are preferably carried out by any hardware device.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

10; 20; 30 pattern
110 obtaining further sensor data
120 determining a reference geometry
130 obtaining sensor data
140 determining a characteristic geometry
150 comparing the characteristic geometry with the reference geometry
160 adjusting a representation of the pattern
165 determining a difference value
170 providing a warning
180 determining at least one calibration parameter
185 adjusting the at least one calibration parameter
190 operating at least one control unit
200a; 200b optical imaging system
210 system
212 one or more interfaces
214 one or more processors
216 one or more storage devices
220 scanning imaging device
222 detector
224 control unit
226 light-conducting element, mirror
228 laser emitter
230 further optical imaging sensor
240 housing
250 sample stage
310 calibration standard
320 reference image
330 auto-phase correlation
340 reference
350 confocal imaging
360 auto-phase correlation
370 adjusting the galvo controller
380 further iteration
410 reference image
420 confocal image
430 original overlay
440 overlay after calibration
500 system
510 optical imaging device
520 computer system

1. A method for an optical imaging system having a scanning imaging device, the method comprising:
obtaining sensor data from a detector of the scanning imaging device, wherein the sensor data comprise a representation of a pattern captured by the detector;
determining a characteristic geometry of the representation of the pattern;
comparing the characteristic geometry with a reference geometry in order to determine a comparison result;
determining at least one calibration parameter for calibrating at least one control unit for moving a beam-conducting element of the scanning imaging device based on the comparison result; and
operating the at least one control unit based on the at least one calibration parameter.

2. The method according to claim 1, further comprising obtaining further sensor data from a further optical imaging sensor of the optical imaging system, wherein the further sensor data comprise a further representation of the pattern captured by the further optical imaging sensor, and determining the reference geometry based on the further representation of the pattern.

3. The method according to claim 2, further comprising adjusting the representation based on the comparison result, determining a difference value between the adjusted representation and the further representation, and determining the at least one calibration parameter further based on the difference value.

4. The method according to claim 2, further comprising, after application of the at least one calibration parameter, re-obtaining the sensor data with a new representation of the pattern, determining a difference value between the new representation and the further representation, and determining the at least one calibration parameter further based on the difference value.

5. The method according to claim 1, wherein the reference geometry is a factory-defined reference geometry or a geometry determined by another scanning imaging device and stored in a memory of the optical imaging system.

6. The method according to claim 1, wherein the at least one calibration parameter is determined such that, after application of the at least one calibration parameter, a field of view of the scanning imaging device corresponds to a field of view of another optical imaging sensor of the optical imaging system within a tolerance range.

7. The method according to claim 1, wherein the at least one calibration parameter is determined such that, after application of the at least one calibration parameter, the characteristic geometry corresponds to the reference geometry within a tolerance range.

8. The method according to claim 1, wherein the comparison result is repeatedly determined and the at least one calibration parameter is repeatedly adjusted.

9. The method according to claim 8, further comprising providing a warning if the characteristic geometry does not correspond to the reference geometry within a tolerance range after repeated adjustment of the at least one calibration parameter.

10. The method according to claim 1, wherein the pattern is a periodic pattern, and the characteristic geometry comprises a periodicity of the representation of the periodic pattern.

11. The method according to claim 10, wherein the periodicity is determined by calculating an auto-phase correlation.

12. The method according to claim 1, wherein the pattern is a two-dimensional periodic pattern, and the characteristic geometry is a periodicity of the representation of the two-dimensional periodic pattern in two dimensions.

13. The method according to claim 1, wherein the beam-conducting element is movable in two dimensions by the control unit and the at least one calibration parameter comprises at least a first scaling factor for scaling a movement of the beam-conducting element in a first dimension and a second scaling factor for scaling movement of the beam-conducting element in a second dimension.

14. The method according to claim 1, wherein the characteristic geometry and the comparison result are determined at start-up of the scanning imaging device, following detection of a vibration of the optical imaging system, and/or according to a prespecified schedule.

15. A system for an optical imaging system, comprising a scanning imaging device, one or more processors, and one or more storage devices, wherein the system is configured to perform the method according to claim 1 by using the one or more processors.
